(19) United States
(12) Patent Application Publication
(10) Pub. No.: US 2003/0225597 A1
(43) Pub. Date: Dec. 4, 2003

(54) Methods and systems for the creation and use of medical information

(76) Inventor: Joseph H. Levine, Great Neck, NY (US)

Correspondence Address: Michael T. Marrah, Sonnenschein Nath & Rosenthal, Wacker Drive Station, Sears Tower, P.O. Box #061080, Chicago, IL, 60606-1080, US

(21) Appl. No.: 10/157,476

(22) Filed: May 29, 2002

(51) Int. Cl. G06F 17/60

(52) U.S. Cl. 705/3

(57) ABSTRACT

Methods and systems for the creation and use of medical information comprising a record system and a healthcare professional network. The inventive record system comprises an expert system and a database system for the collection, storage, manipulation and output of various record system data including member patient electronic medical records, treatment information, patient appointment information, medical definitions, research, condition matrix and network professional information. The various data in the record system may be used in the functions of the record system and expert system, said functions comprising data collection, storage, manipulation and output; call center functionality; providing appointment reminders; controlling medical professional, patient and third party access to record system data; providing for analysis of data for clinical trial applications; providing for research; providing education and training; and providing patient medical record analysis. The professional network comprises leading medical professionals, who may be primarily or exclusively physicians from academic and private institutions throughout the world. The network includes an advisory board of professionals selected from the network population. The network functions comprise providing various data to the record system, treating local patients, treating traveling member patients, responding to emergency needs of patients, assisting in providing information to and enrolling their non-member patient base.

### BACKGROUND OF THE INVENTION

The invention is in the field of medical information, specifically, improved methods and systems for the creation and use of medical information primarily by doctor and patient members as well as other authorized users.

Medical errors, inappropriate care, and untimely or nonexistent access to medical information, including patient records, in times of emergency are significant problems in the current healthcare environment. Medical errors, which may be defined as failures to complete a planned action as intended or the use of a wrong plan to achieve an aim, cause increases in overall healthcare costs and decreases in the quality of care provided to patients. These errors could include the provision of unnecessary or duplicative services and/or improper prescriptions that may cause drug interactions or allergic reactions. It is believed that many of these errors could be avoided by, among other things, access to better medical information during the decision making process.

Currently, the availability of patient data to a treating emergency room physician is spotty and inefficient at best. Currently, emergency room physicians utilize data provided by a spouse, friend, or the patient to identify the patient's condition. On rare occasions, to obtain appropriate patient information, emergency room physicians are able to contact the patient's primary physician and have the necessary information relayed orally or by facsimile. Accessing historical information for recurring hospital patients is also difficult, as emergency room physicians must retrieve archived files and review entire charts for pertinent data. Additionally, these hospital files usually focus only on a patient's specific hospitalizations, and will typically not contain patient history, follow-up information, and test results.

Thus, there is a critical need to provide physicians with access to patients' key medical record data in emergency situations. Quick access to this data may have a significant effect on the ability of the treating physician to properly diagnose and treat the patient.

Similarly, inappropriate care is a matter of concern. As more patients report that they did not receive required care or received unnecessary care, the actions of healthcare providers will come under greater scrutiny. Again, it is believed that improvements in information storage, access and use may help aid in alleviating the instances of inappropriate care given to patients.

Perhaps partly due to the above issues, patients are also demanding more information, more options, and greater involvement in their own healthcare. Today's consumers are taking greater responsibility for their care as they compile health information through the Internet and other methods of research. Armed with this information, they are demanding better access to healthcare providers and are searching for tools that will help them manage their personal health. However, as non-medical practitioners, these consumers may not understand the significance of certain data or the lack thereof. Worse yet, these non-medical practitioner consumers may even input data erroneously. Thus, there is a need for a computerized system that has data input by medical practitioners.

### SUMMARY OF THE INVENTION

A number of these needs are met and advances in art achieved through the provision of the inventive system for the creation and use of medical information. This system comprises a record system and a healthcare professional network. The inventive record system comprises an expert system as well as a database system for the collection, storage, manipulation and output of various record system data including member patient electronic medical records, treatment information, patient appointment information, medical definitions, medical research, condition matrixes and network professional information.

The various data contained in the record system database may be used in performing various functions, such as conducting data collection, storage, manipulation and output; providing call center functionality; providing appointment reminders; controlling medical professional, patient and third party access to record system data; providing for analysis of data for clinical trial applications; providing for research; providing for education and training; and providing for patient medical record analysis. The professional network comprises leading medical professionals who may be primarily or exclusively physicians from academic and private institutions throughout the world. The network includes an advisory board of professionals selected from the network population. The network functions comprise providing various data to the record system, treating local patients, treating traveling member patients, responding to emergency needs of patients, assisting in providing information to and enrolling their non-member patient base.

### BRIEF DESCRIPTION OF THE DRAWINGS

FIG. 1 is a flow chart depiction of the various elements of one embodiment of the record system of the present invention;

FIG. 2 shows an organizational depiction of one embodiment of the invention;

FIG. 3 is an example of an electronic medical record input form showing data fields;

FIG. 4 is a flow chart of steps to enroll patients in the inventive method and system;

FIG. 5 is a flow chart of steps to build the electronic medical record data for a member patient;

FIG. 6 is a flow chart of steps to update the electronic medical record data for a member patient; and

FIG. 7 is a flow chart of steps to provide emergency care to a traveling member patient.

### DETAILED DESCRIPTION

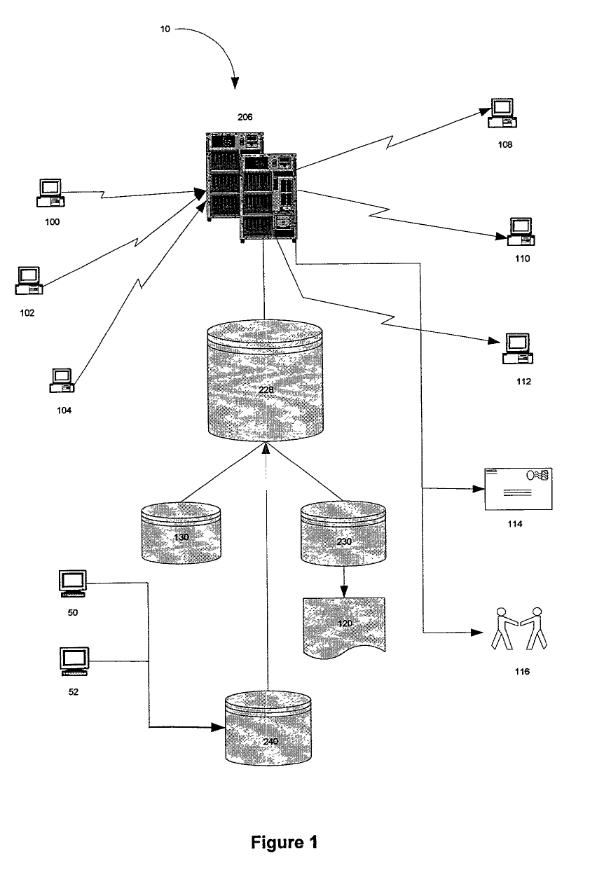

The present invention comprises two primary elements: a record system, shown generally as 10 in FIG. 1; and a healthcare professional network. The record system 10 and professional network are integrated as detailed herein. While the invention may be described herein in a specific embodiment, it is understood that this embodiment of the invention is not limiting and that the invention may be embodied in many different forms.

It is understood that implementation of the invention may involve the use of one or more corporate or other legal entities, to which the patients covered by the inventive systems and methods (identified as “patients”, “members” or “member patients”) enroll and obtain membership. Nevertheless, it is understood that other known implementation and organizational structures are possible and are included within the scope of this invention.

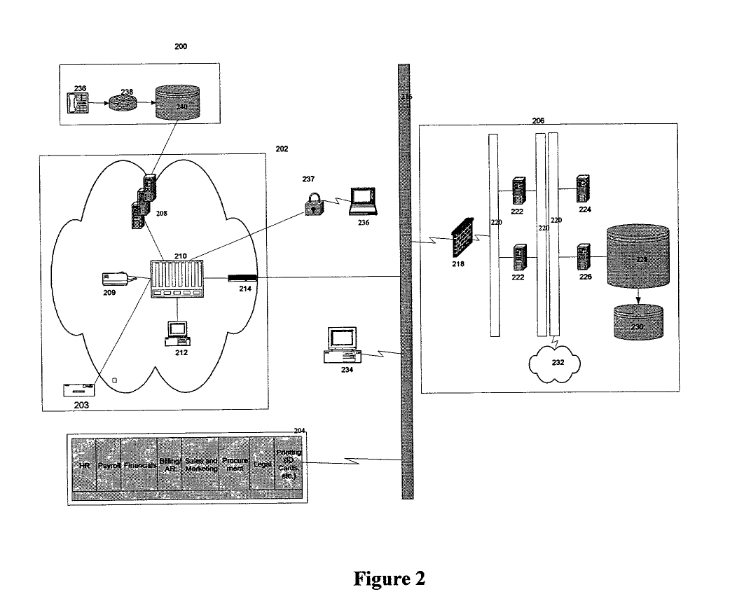

For example, FIG. 2 shows one embodiment of such a corporate structure (identified herein as the “Company”) implementing the record system 10 of the present invention. As shown, the record system 10 is implemented through four modules, a call center 200, Company infrastructure 202, administrative functions 204 and hosting environment 206. In this embodiment, the Company is the primary legal entity which implements the invention and whose membership rolls define the member patients.

In this embodiment, the Company infrastructure 202 includes a computer network, such as a local area network (LAN) or wide area network (WAN). This computer network comprises in operative connection, at least one network computer server 208 to perform email 203, facsimile and other known network functions and at least one network hub 210 in operative connection with at least one peripheral 209; at least one network access computer or terminal 212 internal to the Company; and at least one router 214 for connection of the computer network to other networks.

As shown in FIG. 2, the computer network may be connected to the Internet and the hosting environment 206 through an Internet service provider 216. Such a hosting environment 206 may include firewall security provisions 218, virtual local area networks (VLANS) 220, at least one Internet web server 222, at least one application server 224, and at least one database server 226 to maintain and control the record system's database 228 and, if necessary, any secondary data warehouses 230 used by the record system 10. Such a hosting environment 206 may also include backups 232 of record system 10 information.

As shown in FIG. 2, an authorized user 234 of the record system 10 may obtain access to the system 10 through the Internet and the Internet service provider 216. Similarly, other authorized users 236 may obtain direct access to the Company's LAN and the record system 10 through known secure communication methods 237.

Administrative functions 204 of the Company, including human resources, payroll, financial information preparation and maintenance, billing and accounts receivable, sales and marketing, purchasing and procurement, legal consultation and printing functions, may be performed within the Company or outsourced to third-party vendors.

The next module identified in FIG. 2, the call center 200, provides for and maintains communication between the Company infrastructure 202 and outside callers to the Company. Thus, information may be transferred between telephone callers 236 and the record system's database 228, through call center routers 238 and at least one call center database 240.

The inventive record system 10 comprises an expert system and a database system for the collection, storage, manipulation and output of various data from the database system of the data including member patient electronic medical records (“EMRs”), treatment information, patient appointment information, medical definitions, medical research, condition matrix and practitioner information. The various data in the database system of the record system 10 may be used in the functions of the record system 10, said functions comprising data collection, storage, manipulation and output; call center functionality; providing appointment reminders; controlling medical professional, patient and third party access to record system data; providing for analysis of data for clinical trial applications; providing for research; providing education and training; providing patient medical record analysis.

The professional network comprises leading medical professionals who may be primarily or exclusively physicians from academic and private institutions throughout the world. The network also includes an advisory board of professionals selected from the network population. The network functions comprise treating local patients, treating traveling member patients, responding to emergency needs of patients, assisting in providing information to their non-member patient base, providing data to the treatment information database of the record system 10, and other functions as discussed below.

The board functions comprise participation in medical education and content, technology input, quality assurance, selection of EMR content, the credentialing of network professionals, and other functions as discussed below.

I. Record System

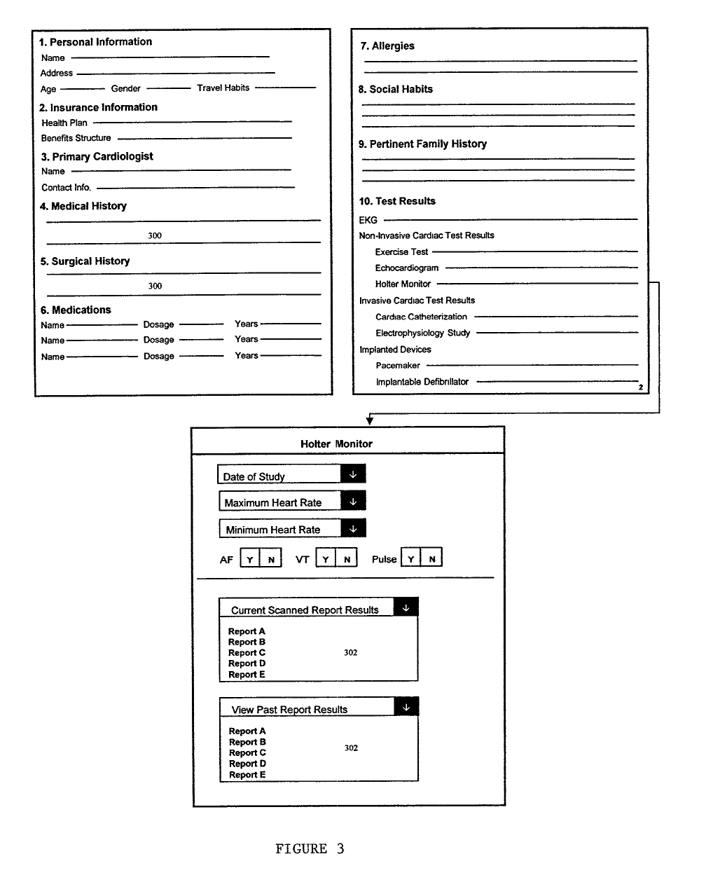

A. EMR. This data of the database system of the record system includes a secure, confidential, reliable abstract of each member patient's current, critical medical history and test results. The types of data to be included in the EMR will be selected by the board to be the most important patient data needed in an emergency situation and may include a patient's demographic information and historical data and test results as well as other medical data including: current and past problems experienced by the patient; current medications and allergies; electronic pictures of some test results (e.g., EKG results); and video of medical procedures. It is envisioned that for each test or entry, a portion of data entry will exist for later data. Moreover, a scan of the test documents may be present to deliver on demand in emergency situations. An example of the types of information which may be in the EMR is shown in FIG. 3, which illustrates a sample data entry form identifying cardiac medical record data fields for input into an EMR of the record system 10. Using such a form, members' medical records will be captured in pre-defined fields 300 or scanned and maintained as an image (e.g., electrocardiogram) 302 for future use.

This record system 10, including patients'EMRs, will be accessible to the treating physician whether in an emergency room or in a network professional's office. The EMR will also ensure each member patient's primary network physician has up-to-date information as to the type of treatment the member received while under another network professional's care, for example while traveling.

Member patients may also have access to the record system 10, including their EMR, allowing them the opportunity to conduct research and become better educated and informed about their own case.

B. Treatment Information. The treatment information which is part of the record system 10, identifies frequency and types of treatment options for, among other ailments, the conditions identified in a condition matrix. The treatment information comprises treatment recommendations of recognized panels of experts such as those contained in the guidelines of the American College of Cardiology and, in addition, will include statistical analysis of the treatments or tests historically given for various medical conditions by the network professionals. As such, the treatment information for surveillance of patients with various conditions extends existing guidelines such as those of The American College of Cardiology and The American Heart Association.

The treatment information may be generated in at least two ways. First, surveys of network professionals may be conducted to establish baseline treatment statistics including the types of treatments ordered for given conditions, when such treatments are usually performed in the course of treatment.

Second, this baseline treatment information may be supplemented by patient outcome-based data. Specifically, as the network professionals track the efficacy of various treatment protocols, the outcome data may be added to the baseline information. In this way, the treatment information will provide not only statistics regarding the types of treatments usually offered, but the effectiveness of the various options for given conditions. Thus, a source of the treatment information will be the network professionals and their practices.

It is envisioned that the expert system rules defining the matrix of various cardiac conditions and the guidelines for treatment for each variation will populate a rule engine of an expert system. This expert system will thus be an electronic tool that will be used to audit a members record for missing critical tests that are advised and covered by published guidelines or that represent consensus care of our expert physician group. Alerts of deviation from these standards of care may be available to the member or his/her physician and will help to prevent the member from undertesting (and falling through the cracks of the healthcare system) or overtesting leading to waste and abuse.

The treatment information may be accessible to and may assist network professionals and members with research efforts or benchmarking care provided or received. In addition, non-member patients may be granted limited access to the treatment information for research purposes. For example, non-member patients may be allowed access to the treatment information for research or training purposes based on specific condition information input into the record system 10. Finally, medical students and other medical professionals may be granted access to the treatment information for educational purposes as further described below.

C. Appointment Reminder Information and Functionality. This element of the record system provides members with reminders for upcoming testing via the Internet and/or postal mailings 114. The testing dates and frequencies are determined by the physician and are part of the EMR.

D. Medical Definitions. This element of the record system provides member patients with “lay-person” definitions for terms specifically mentioned in their EMRs. These definitions are created and updated by the advisory board and/or the chief medical officer. It is envisioned that these glossary terms will assist a patient in understanding their medical information as well as educational materials related to their case.

E. Medical Research. This data element contains information and articles that are specifically related to conditions in a condition matrix. These articles may be written by network professionals, derived from medical journals or edited/abstracted by medical professionals within the Company. Members may educate themselves on the most recent studies and research being conducted as it relates to the care they are receiving and network professionals may educate themselves on the current medical research and state of the art. The expert system described in A and B above will function as a disease specific search engine to match appropriate content with patients with particular medical problems.

F. Data Mining.

Portions of EMR data may be collected through the record system 10 and may be stored in a separate data mining database 120 or a medication/allergy conflicts database 130. This data in the record system 10 may be mined in conducting research or clinical trials for medical conditions. The comprehensive database of the record system 10 expedites the research and clinical trial process, thereby reducing costs and improving speed to market for new products. To the extent not already a part of the data mining database 120 or allergy database 130, pertinent medical and demographic data would be input and reviewed by network professionals or other medical professionals to ensure all information is accurate and appropriate. In all cases, whether in a separate data warehouse or part of the EMR database, the data will be sanitized and patient confidentiality maintained at all times. This data may also be used to develop patient outcome mediated guidelines.

Medical device and pharmaceutical companies conduct clinical trials to test new and/or enhanced products to receive regulatory approval to go to market. These trials are costly and time consuming. One of the most challenging processes for clinical trials is the identification of appropriate patients that are willing to participate in the trial. Using the record system 10 data and relationships with network professionals, the invention may assist medical device and pharmaceutical companies with clinical trials in three key areas:

Provide a channel to patients through network professionals;

Aid in the selection and screening of potential candidates for clinical trials;

Educate patients and create demand for participation in clinical trials; and

Digitally track information for participating patients.

With the large amount of emerging technology in the medical device field, regulatory requirements for post market surveillance (maintaining accurate patient demographic information following an implant) may increase. Thus, the invention may assist medical device companies in two key areas to ensure regulatory compliance:

Identify, recruit, register, and manage patients; and

Conduct post market surveillance.

Medical device and pharmaceutical companies conduct market research to develop new products or identify new uses for current products. In addition, these companies have large ongoing budgets to increase use of devices and drugs for already approved indications. For example, it is estimated that only 20% of patients who qualify, on clinical grounds, for an implantable defibrillator, using already approved indications of need, actually receive one.

The inventive record system 10 may be used to assist these companies with several areas of market research including:

Identify, to their physicians, patients with specific diagnoses or implantable devices who may be eligible for broader treatment options;

Provide geographically generic patient treatment data;

Develop customized ad hoc reports for specific conditions;

Provide channel to patients through network professionals, or through web links targeted to specific disease states; and

Identify practice patterns of the various types of specialties and subspecialties.

The present invention may also be used to research, test and implement telemedicine applications. As technology develops, there will be opportunities to monitor and alter treatments for patients while the patient is at home. Thus, the record system data may assist these companies in four areas:

Test possible technological applications;

Test remote monitoring;

Determine where telemedicine advances fit in the day-to-day care of patients; and

Provide a clinical record to collect patients'remote testing results.

G. Condition Matrix. The record system database may also contain a matrix of abnormal conditions, created and maintained by the advisory board of network professionals. Currently, cardiac diagnoses are divided into 30-50 known variations as outlined by the ICD-9 categories. It is possible, via a series of rules to better characterize a person's medical condition and thousands of variations are possible. This type of characterization will be done electronically and automatically using the EMR and rules set by the advisory board. Ultimately, it is envisioned that patient outcomes of patients characterized by the series of rules will, in turn, be followed and these outcomes will determine subsequent rules and guidelines for care. (See H below)

H. Expert system. The expert system of the present invention may comprise expert system rules and expert system engine. The rules may be created and maintained by the network professionals to control certain automatic capabilities of the record system 10. For example, for each category of tests in a member patient's EMR, there will be fields indicating the most recent test date, the monthly interval for testing, and the next testing date. The expert system, based on the next testing date field, will trigger the appointment reminder functionality to notify the member of the pending testing date appointment.

Through the expert system rules developed by the advisory board, the expert system may also drive the record system's analysis of member patients' EMRs. For example, once a patient's EMR is in the record system 10, the expert system may analyze the data in the EMR and identify a possible correlation between the patient's medical data and one or more conditions identified in the condition matrix. Based on this correlation, the expert system may analyze published medical guidelines or physician survey data to identify guidelines for medical testing which are most likely to be relevant to such a condition. Similarly, the expert system may analyze the treatment information to identify additional information which may be relevant to such a condition. It is envisioned that each rule and medical guideline will be based upon rational interpretation of published medical data or survey information obtained from leading practitioners. This data will be made available to physician patients.

Other functions of the expert system may include determining what, if any, tests or other medical data may be missing from or out of date in a patient's EMR given the patient's condition and related treatment information. Such functions of the expert system may also include flagging relevant medical research to supplement and support these functions.

All condition, research and treatment data may then be output to the appropriate network professionals and/or the patient himself.

As noted above, published guidelines may not be available for all medical decisions, tests, or therapies. These missing data points will be identified and survey questions developed. The leading physicians will fill out the surveys the results of which will be presented. Ultimately, the system will be used to develop the true guidelines (confirm those that are published and develop those that are not) by comparing testing frequencies with patient outcomes. In this way, a guidelines benefit can be proven.

I. Professional Information. The record system 10 may also contain feedback information on network professionals obtained from member patients.

J. Educational Functionality

Non-member patients and non-network professionals 112, including medical students and pharmaceutical and medical device company representatives, may access a simulator version of the record system 10 that may be used to develop educational information. This functionality may also be made available to member professionals for continuing medical education. Specifically, non-member patients may conduct research in the record system 10 by inputting various medical data into the system and utilizing the expert system to ferret out, among other things, relevant medical conditions, treatment information and medical research from the record system 10.

Additionally, the record system 10 may be used for medical education for network professionals, medical students and for pharmaceutical and medical device employees. For example, case reports of hypothetical or actual patient data may be used with the record system 10 to guide students through the expert system to instruct on analysis of the cases.

In addition, the record system 10, with its integration of research materials, condition and treatment information, may be used by healthcare professionals within each subspecialty to consider the applicability of treatment modalities falling within another subspecialty. This will refocus treatment to the patient as a whole.

The record system 10 may also support educational efforts of medical device and pharmaceutical companies who may use network professionals' and the Company's Internet site as vehicles for educating physicians, patients, and company employees on specific uses of medical devices and pharmaceuticals. For example, the simulator version may be used in a mock evaluation situation to illustrate the treatment information and device options for patients with a specific condition state and with specific test results.

In all cases, the rules and medical content may be accessed directly via input known or presented data points. When the inventive system is operated as a simulator, not only will a physician be able to enter a known data point but they will be able to enter a change specific data point at any time during the interaction to create unlimited, “new” hypothetical patients. For each, the relevant medical content will be made available. In each case, the rules and content chosen for each decision node of the expert system will be made available and the information will be presented as medical data is input.

For the case of physician education tools, it is envisioned that the system may have known cases and choices available for review. Not only will this allow a physician to choose among various clinical circumstances by entering and changing data on their own to create new hypothetical cases but we also will track their choices of therapy for each condition by using a question and answer format. These choices will be saved in a data base and used for subsequent market research. Hence, the educational tools themselves will function as a market research environment.

L. Call Center Functionality. This element may be available for medical emergencies to refer a member to a physician in the member's area, whether local or when traveling, or to provide back-up information to an emergency room physician. In addition, the member's EMR or other record system 10 information may be forwarded to the treating physician by the call center when the treating physician is unable to access the EMR electronically through the Company's website.

The invention's call center 200 may be comprised of two service centers as shown in FIG. 1 or a single center providing both sets of functionality defined below. As shown in FIG. 1, an emergency service center 50 may operate as a fault tolerant, 24×7×365-operating center. As shown in FIG. 7, the emergency service center 50 fields 700 emergency calls from members or network physicians and inputs call and record system data into the record system 10 through the call center database 240. It may function to refer (702, 704) traveling members to a network professional, as well as to send 706 record system data to a network professional to provide appropriate patient care (708, 710). The emergency call center may be equipped to send and receive data to a call center database 240 and to send record system data to network professionals by e-mail or facsimile or other known method upon proper authentication.

The second service center, a customer service center 52, provides general service functionality for new and existing members, as well as network professionals. The customer service center staff have access to the record system 10 and will provide answers to member questions, enroll members in Company services, request changes to medical records, and provide information to physicians about their member enrollment. In addition, the customer service center may handle questions related to the website content and functionality and may input call and record system data into the record system 10 through the call center database 240.

Identification of members and physicians through the service centers (50, 52) may be determined by individually assigned ID and PIN numbers or other known security means. To provide security and privacy for the member medical records, requests to transfer EMRs will require confirmation of additional criteria to identify the members or physicians.

The emergency call center 50 may be staffed and run in-house by the Company. However, either customer service center 52 functions may be outsourced. Technical infrastructure may be outsourced and may be common between both service centers.

K. Enrolling New Patients and Inputting Data into the Record System

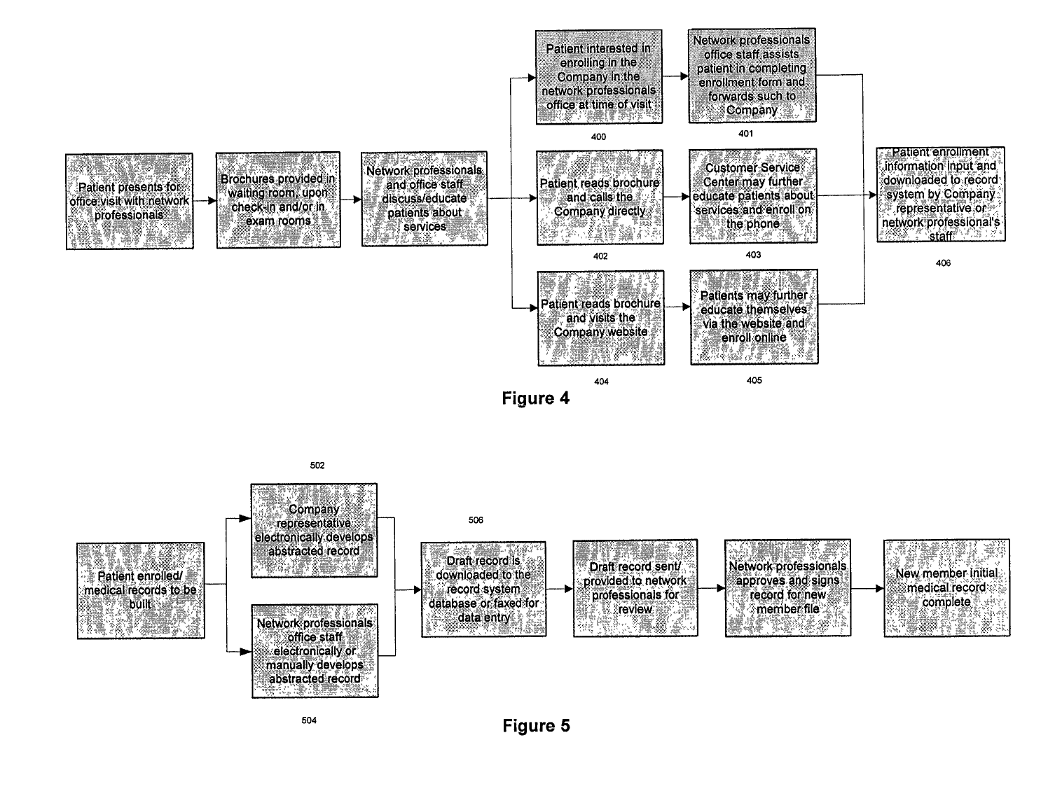

FIG. 4 depicts the steps for enrolling new patients into the inventive systems and methods. Of particular importance is that a non-member patient may have at least three distinct means of enrolling in the Company's system: through their network professional (400, 401); through direct contact with the Company through the call center 200, (402, 403); and through the Company's website (404, 405).

FIG. 5 shows a flow chart identifying the steps of inputting medical record data into the record system. All information is input into the record system 10 by trained medical professionals, either by representatives (502, 102) of the Company or by the network professionals' staff (504, 104). Thereafter, the record is reviewed by network physicians and updated regularly. This process ensures the data is accurate and includes only the most critical, clinical information.

The patients' records will be built by entering data directly into the database (502, 504, 506). Information will also be scanned and maintained as an image in the record.

Based on at least enrollment levels in network professional offices, the Company may select the most cost-effective method to build new members' EMRs. For example, if a network office has a large member patient base, a Company representative may be located on site to build members' EMRs 406. This process will be seamless to the network professional's office staff.

If enrollment volumes are low, the Company may provide additional compensation to the network professional's office staff to assist in building records 406. Patients of non-network professionals will be responsible for obtaining their medical information from their primary care physicians for the Company to build the record.

M. Updating the Record System

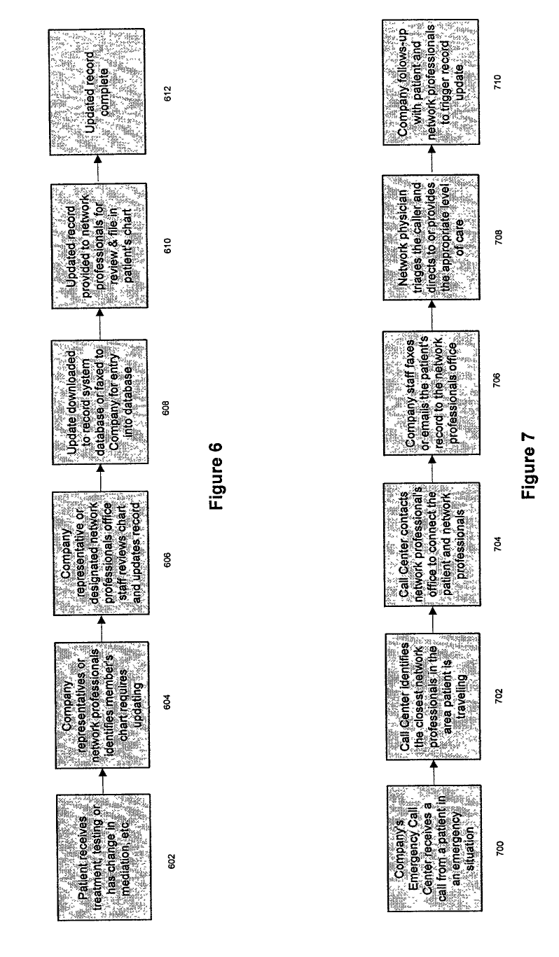

FIG. 6 graphically depicts the steps involved in updating a patient's medical records in the record system 10. Members' medical records must be updated after each visit to a physician and will be reviewed on a regular basis for follow-up information. This update will ensure the record system has the most up-to-date, accurate information. Updating a EMR comprises the steps of treating, testing or changing the patients' care regimen in some way 602, identifying that the patients' records need updating 604, locally editing the record data by a Company representative or a network professional's staff member 606, downloading updated data to record system or faxing data to Company for downloading into record system 608, providing the updated record to network professional for review and filing 610 and 612.

N. Record System and Web Hosting Infrastructure

The record system 10 provides a secure, electronic, transportable EMR. The EMR will be available to members and network professionals via secure internet connections, as well as by facsimile, e-mail and other known transmission means.

The data stored within the record system 10 may be primarily codified (e.g., not free text but entered into pre-determined fields) using HIPAA compliant, standard nomenclature, including ICD-9 codes. These data fields will facilitate reporting and data mining activities. Historical record system data will be maintained and integrated as part of the data architecture.

Member enrollments and updates may be entered into the record system 10 using web-based applications by the network professionals trained staff or trained Company representatives. Changes such as demographics will be completed by the member, the network professional's staff or a Company representative. Additional medical changes will be completed by the physician staff or a Company representative. The record system database and the flow of private, identifiable medical information over the Internet may be secured using a redundant network with known, multi-path security. For example, the VPN systems will encrypt data between the accessing systems and the web host network to prevent snooping on client and server data exchanges. Encryption may use Secure Socket Layer (SSL) technology to prevent others from reading the information. Redundant firewalls 218 may provide network security by performing inspection of each data packet sent from the front-end servers 222 to the data server 226 containing the record system 10 database 228 to help ensure the privacy of the medical data and compliance with HIPAA guidelines.

O. Internet Functionality

A website established by the Company may provide members 108, network professionals 110, and Company representatives 116 with access to the record system 10, including EMRs, medical research, treatment information, educational information and other relevant information via the Internet. Marketing and enrollment information may also be available. Members and non-members will be able to purchase and access additional features, such as certain educational materials, chat rooms, and question/answer sessions with physicians for a nominal fee.

Security into the website may be handled using login identification and PIN numbers and other known security technologies. Authentication of users may be verified using digital certificates and the SSL encryption for secure data exchange. Firewalls will allow authenticated users access to only those services permitted, as determined by rules defined by the web host. In addition, there may be application-specific security features such as username-password to further protect data access. Based on the user identification, role based security will determine the type and amount of access a user will have to the Company's site.

As shown in FIG. 2, web hosting may be outsourced to a vendor that will provide complete services for website access, security, application/system monitoring, technical support and hosting of the entire infrastructure, including the record system database application. Because access to the EMRs is critical, especially in emergency situations, the hosting environment may be a redundant, highly available solution to minimize the risk of site failure. In addition, all or critical parts of the database may be downloaded or backed-up daily.

P. Customizable Access to Record System

Access to the various data in the record system 10 may be varied by individual member or categories of members. For example, the Company may provide a travel service which would allow members access to the professional network on a per trip basis. This service may be ideal for patients who travel only one to two weeks per year.

Such a travel service may include remote access by patients to their EMR; however, such patients would not have access to the other features of the record system 10 such as appointment reminders, access to educational content, expert system output, etc.

Another category of service would provide all of the features of the record system 10 and year-round access to the professional network. This service may be ideal for patients who travel greater than two weeks per year and who wish to benefit from the comprehensive scope and portability of the record system 10. Various intermediate categories of service and access to the record system 10 and network professionals are possible and contemplated herein.

II. Professional Network

The professional network may be comprised of leading medical professionals, for example, cardiologists, from recognized academic and private institutions throughout the world. The physicians will be committed to giving care to member patients in emergency situations while traveling on a priority basis. Network professionals may be located in major metropolitan cities and travel destinations in North and Central America, Europe, and the Middle East.

The network may include a mix of clinical private practices and academic university and/or hospital based practices of all sizes. An appropriate mix of clinical, electrophysiology, heart failure, and interventional cardiologists may be included in the network to ensure the Company has the right physicians to care for all types of problems.

The network may include a mix of clinical private practices and academic university based practices. Additionally, academically focused network professionals will provide key support to developing and maintaining the treatment information and are affiliated with key research centers for clinical trials.

The Company may have full nation-wide coverage. Broad coverage is critical to providing members' access to network professionals while traveling. In addition, coverage may be sought for key international travel destinations. The Company may select professionals for entry into the network based on specific credentialing criteria such as:

Recognized leaders in their field;

Proven clinicians in practice;

Published articles;

Participants in clinical trials;

Academic oversight;

Professional leadership roles;

Hospital leadership roles;

Geographic location

Size of physicians practice (i.e., number of patents); and

Number of physicians in the practice. and provide diverse geographic coverage to members.

Physician Advisory Board

A select group of network professionals may form an advisory board within the network. The advisory board may provide guidance to the network professionals and the Company's officers. This board may offer medical insights in future developments of the record system technology, standard treatment information, and website content as well as provide the information and services relating to the record system described above. The advisory board may consist of 30-40 professionals, all of whom will be members of the network.

What is claimed is:

1. A system for the creation and use of medical information comprising:
a record system having a database system and expert system;
said database system for the collection, storage, manipulation and output of record system data, said data comprising patient electronic medical records, treatment information, patient appointment information, medical definitions, medical research, a condition matrix and professional information;
said expert system comprising a set of predetermined rules and functioning to automatically analyze at least portions of said record system data; and
a professional network comprising medical professionals.

2. The system of claim 1 wherein said network determines the content and format of the patient electronic medical record.

3. The system of claim 1 wherein said network determines said rules.

4. The system of claim 1 wherein said network professionals supply the medical research data to the record system.

5. The system of claim 1 wherein said network professionals provide said treatment information to said record system.

6. A system for the creation and use of medical information comprising:
a record system having a database system and an expert system;
said database system for the collection, storage, manipulation and output of record system data, said data comprising patient electronic medical records, treatment information, patient appointment information, medical definitions, medical research, a condition matrix and professional information;
said expert system comprising a set of predetermined rules and functioning to automatically analyze at least portions of said record system data; and
wherein said treatment information comprises statistical tabulations of treatment options for medical conditions and outcome-based data regarding said treatment options.

7. The system of claim 6 further comprising a professional network comprising medical professionals wherein said treatment information is created by compiling data from surveys of said network.

8. The system of claim 7 wherein said treatment information is supplemented by patient outcome based data.

9. A system for the creation and use of medical information comprising:
a record system having a database system and an expert system;
said database system for the collection, storage, manipulation and output of record system data, said data comprising patient electronic medical records, treatment information, patient appointment information, medical definitions, medical research, a condition matrix and professional information;
said expert system comprising a set of predetermined rules and functioning to automatically analyze at least portions of said record system data; and
wherein said expert system, based on a set of predetermined rules, may automatically analyze said electronic medical records in light of said condition matrix to correlate said record with one or more medical conditions in said matrix.

10. The system of claim 9 wherein said expert system may, based on said correlation, automatically identify said medical research relevant to said condition.

11. The system of claim 9, wherein said expert system may, based on said correlation, automatically identify said treatment information relevant to said condition.

12. The system of claim 11, wherein said expert system, may, based on said correlation and said identified treatment information, automatically flag information or tests which may be missing from the patient's electronic medical record.

13. A system for the creation and use of medical information comprising:
a record system having a database system and an expert system;
said database system for the collection, storage, manipulation and output of record system data, said data comprising patient electronic medical records, treatment information, patient appointment information, medical definitions, medical research, a condition matrix and professional information;
said expert system comprising a set of predetermined rules and functioning to automatically analyze at least portions of said record system data; and
further comprising a Company having trained medical professionals wherein said electronic medical record data is input by said trained medical professionals.

14. A system of claim 9, wherein said expert system is used as an education tool.

15. The system of claim 14 wherein said expert system is supplied hypothetical electronic medical record data upon which to base its analysis.

16. The system of claim 14 wherein said patients are members of an organization having member patients and implementing said system and wherein said expert system is supplied non-member patient medical record data upon which to base its analysis.

17. A system for the creation and use of medical information comprising:
a record system having a database system for the collection, storage, manipulation and output of record system data, said data comprising patient electronic medical records, treatment information, patient appointment information, medical definitions, medical research, a condition matrix, an expert system and professional information; and
wherein said electronic medical records are used to identify potential patient candidates for research trials.

18. The system of claim 1 wherein a patient's electronic medical records are accessible to the patient and a treating network physician when the patient is traveling.
